(19) United States
(12) Patent Application Publication
(10) Pub. No.: US 2026/0145229 A1
(43) Pub. Date: May 28, 2026

(54) Soft Magnetic Powder, Dust Core, Magnetic Element, And Electronic Device

(71) Applicant: SEIKO EPSON CORPORATION, Tokyo (JP)

(72) Inventor: Toshiki SANO, Hachinohe (JP)

(21) Appl. No.: 19/400,767

(22) Filed: Nov. 25, 2025

(30) Foreign Application Priority Data
Nov. 26, 2024 (JP) 2024-205137

(51) Int. Cl. B22F 1/052; B22F 1/065; B22F 1/103; C22C 38/02; C22C 38/18; H01F 1/147; H01F 3/08

(52) U.S. Cl. CPC B22F 1/052; B22F 1/065; B22F 1/103; C22C 38/02; C22C 38/18; H01F 1/14766; H01F 3/08; B22F 2301/35; B22F 2304/10

(57) ABSTRACT

A soft magnetic powder contains: Fe; Si having a content of 2.5 mass % or more and 7.5 mass % or less; Cr having a content of 1.0 mass % or more and 10.0 mass % or less; and impurities of 1.0 mass % or less. An average circularity is 0.80 or more and less than 0.95, in a cumulative particle size distribution curve, when D10 is defined as a particle diameter at which a cumulative value on the small diameter side is 10%, D50 is defined as a particle diameter at which a cumulative value is 50%, and D90 is defined as a particle diameter at which a cumulative value is 90%, the particle diameter D50 is 3.0 μm or more and 11.0 μm or less, a particle diameter difference D90−D10 is 4.0 μm or more and 22.0 μm or less, and A×B is 1.20 or more and 2.40 or less, where A [μm] is the particle diameter D50 and B [m²/g] is a specific surface area.

### BACKGROUND

The present application is based on, and claims priority from JP Application Serial Number 2024-205137, filed Nov. 26, 2024, the disclosure of which is hereby incorporated by reference herein in its entirety.

### 1. Technical Field

The present disclosure relates to a soft magnetic powder, a dust core, a magnetic element, and an electronic device.

### 2. Related Art

JP-A-2024-055483 discloses a soft magnetic powder containing Fe as a main component, Si having a content of 2.5 mass % or more and 6.5 mass % or less, Cr having a content of 1.0 mass % or more and 10.0 mass % or less, S having a content of 0.0020 mass % or more and 0.0070 mass % or less, and impurities, in which, when an oxygen content in a mass ratio is defined as A [ppm] and a specific surface area is defined as B [m²/g], a ratio A/B is 3000 or more and 8000 or less.

According to such a soft magnetic powder, a soft magnetic powder in which an oxygen content with respect to a specific surface area is optimized is obtained. That is, when the ratio A/B is within the above range, it is possible to implement a soft magnetic powder in which the oxygen content is optimized according to a particle diameter. As a result, an oxide proportion in a green compact is reduced, and a soft magnetic powder is obtained in which insulation properties between particles are ensured.

JP-A-2024-055483 is an example of the related art.

In the soft magnetic powder described in JP-A-2024-055483, it is a problem to reduce an amount of a binder to be added during molding. When the amount of the binder to be added during molding is large, a density of a molded body decreases, and magnetic properties of the molded body decrease. On the other hand, when the amount of the binder to be added is reduced, a mechanical strength of the molded body decreases.

### SUMMARY

A soft magnetic powder according to an application example of the present disclosure contains: Fe as a main component; Si having a content of 2.5 mass % or more and 7.5 mass % or less; Cr having a content of 1.0 mass % or more and 10.0 mass % or less; and impurities having a total content of 1.0 mass % or less. An average circularity calculated based on an area and a perimeter of particles is 0.80 or more and less than 0.95, in a volume-based cumulative particle size distribution curve measured by a laser diffraction method, when D10 is defined as a particle diameter at which a cumulative value on the small diameter side is 10%, D50 is defined as a particle diameter at which a cumulative value on the small diameter side is 50%, and D90 is defined as a particle diameter at which a cumulative value on the small diameter side is 90%, the particle diameter D50 is 3.0 μm or more and 11.0 μm or less, a particle diameter difference D90−D10 between the particle diameter D90 and the particle diameter D10 is 4.0 μm or more and 22.0 μm or less, and A×B is 1.20 or more and 2.40 or less, where A [μm] is the particle diameter D50 and B [m²/g] is a specific surface area.

A dust core according to an application example of the present disclosure includes:
the soft magnetic powder according to the application example of the present disclosure.

A magnetic element according to an application example of the present disclosure includes:
the dust core according to the application example of the present disclosure.

An electronic device according to an application example of the present disclosure includes:
the magnetic element according to the application example of the present disclosure.

### BRIEF DESCRIPTION OF THE DRAWINGS

FIG. 1 is a plan view schematically showing a coil component of a toroidal type.

FIG. 2 is a transparent perspective view schematically showing a coil component of a closed magnetic circuit type.

FIG. 3 is a perspective view showing a configuration of a mobile personal computer which is an electronic device according to the embodiment.

FIG. 4 is a plan view showing a configuration of a smartphone which is an electronic device according to the embodiment.

FIG. 5 is a perspective view showing a configuration of a digital still camera which is an electronic device according to the embodiment.

FIG. 6 shows Table 1 indicating configurations, production conditions, and evaluation results of the soft magnetic powders of sample Nos. 1 to 11.

FIG. 7 shows Table 2 indicating the configurations, the production conditions, and the evaluation results of the soft magnetic powders of sample Nos. 12 to 18.

FIG. 8 shows Table 3 indicating the configurations, the production conditions, and the evaluation results of the soft magnetic powders of sample Nos. 19 to 27.

### DESCRIPTION OF EMBODIMENTS

Hereinafter, a soft magnetic powder, a dust core, a magnetic element, and an electronic device of the present disclosure will be described in detail based on a preferred embodiment shown in the accompanying drawings.

### 1. Soft Magnetic Powder

A soft magnetic powder according to the embodiment is a metal powder exhibiting soft magnetism. The soft magnetic powder can be applied to various uses, for example, production of various molded bodies such as a dust core and an electromagnetic wave absorber by binding particles.

### 1.1. Overview

A soft magnetic powder according to an embodiment contains Fe (iron) as a main component, Si (silicon) having a content of 2.5 mass % or more and 7.5 mass % or less, Cr (chromium) having a content of 1.0 mass % or more and 10.0 mass % or less, and impurities having a total content of 1.0 mass % or less.

In addition, the soft magnetic powder according to the embodiment satisfies the following four elements (a) to (d).
(a) An average circularity calculated based on an area and perimeter of particles is 0.80 or more and less than 0.95.
(b) In a volume-based cumulative particle size distribution curve measured by a laser diffraction method, when D10 is defined as a particle diameter at which a cumulative value on the small diameter side is 50%, the particle diameter D50 is 3.0 μm or more and 11.0 μm or less.
(c) In a volume-based cumulative particle size distribution curve measured by a laser diffraction method, when D10 is defined as a particle diameter at which a cumulative value on the small diameter side is 10% and D90 is defined as a particle diameter at which a cumulative value on the small diameter side is 90%, a particle diameter difference D90−D10 between the particle diameter D90 and the particle diameter D10 is 4.0 μm or more and 22.0 μm or less.
(d) when a particle diameter D50 is defined as A [μm] and a specific surface area is defined as B [m²/g], A×B is 1.20 or more and 2.40 or less.

According to such a configuration, even when the amount of the binder to be added during molding is kept to be small, a soft magnetic powder capable of producing a molded body having high density and high strength is obtained. That is, by using the soft magnetic powder according to the embodiment, in the molded body to be produced, even when the amount of the binder to be added is reduced to enhance a space factor of the soft magnetic powder, a decrease in mechanical strength can be prevented. Accordingly, it is possible to produce a molded body that has good magnetic properties and is less likely to cause defects such as chipping and crackings.

### 1.2. Composition

Fe is a main component of the soft magnetic powder. The main component refers to an element having a highest content in terms of an atomic ratio. Fe affects basic magnetic properties of the soft magnetic powder.

The content of Fe is not particularly limited, and is preferably 80.0 mass % or more, and more preferably 85.0 mass % or more.

The content of Si is 2.5 mass % or more and 7.5 mass % or less, preferably 2.7 mass % or more and 5.0 mass % or less, and more preferably 3.0 mass % or more and 4.5 mass % or less. When the content of Si is within the above range, a molded body having higher permeability can be obtained. When the content of Si is less than the lower limit value, magnetic properties such as a permeability and a DC superimposition characteristic decrease. On the other hand, when the content of Si is more than the upper limit value, the soft magnetic powder is hard and the filling properties decrease, and thus a density of the molded body decreases.

The content of Cr is 1.0 mass % or more and 10.0 mass % or less, preferably 1.2 mass % or more and 6.0 mass % or less, and more preferably 1.4 mass % or more and 3.0 mass % or less. When the content of Cr is within the above range, an oxidation resistance of the soft magnetic powder is enhanced, and an amount of oxide is optimized. Accordingly, it is possible to ensure the insulation properties between the particles during compacting while enhancing a weather resistance of the soft magnetic powder and spheroidization of the particles. As a result, it is possible to implement a soft magnetic powder capable of improving magnetic properties during compacting and producing a molded body capable of coping with a high voltage. When the content of Cr is less than the lower limit value, the oxidation resistance of the soft magnetic powder decreases. On the other hand, when the content of Cr is more than the upper limit value, an amount of Fe relatively decreases, the amount of oxide is excessive, and the spheroidization is inhibited, so that a density of the molded body decreases, and magnetic properties such as the permeability, the DC superimposition characteristics, and a saturation magnetic flux density decrease.

A mass ratio of the content of Si to the content of Cr is defined as Si/Cr. The mass ratio Si/Cr is preferably 0.30 or more and 5.00 or less, more preferably 0.40 or more and 3.00 or less, and further preferably 0.60 or more and 1.00 or less. When the mass ratio Si/Cr is within the above range, a balance between the content of Si and the content of Cr can be optimized. Accordingly, it is possible to implement a soft magnetic powder capable of producing a molded body having good magnetic properties without decreasing the withstand voltage.

The soft magnetic powder may further contain Al. The content of Al is preferably 0.50 mass % or less, more preferably 0.05 mass % or more and 0.40 mass % or less, and further preferably 0.09 mass % or more and 0.30 mass % or less. When the content of Al is within the above range, the soft magnetic powder can be spheroidized. When the content of Al is within the above range, similarly to Cr, the oxidation resistance of the soft magnetic powder is enhanced, and the amount of oxide is optimized. Accordingly, it is possible to ensure the insulation properties between particles during compacting while enhancing a weather resistance of the soft magnetic powder. As a result, it is possible to implement a soft magnetic powder capable of improving magnetic properties during compacting and producing a molded body capable of coping with a high voltage. In addition, when the content of Al is within the above range, the surface tension of a molten metal can be reduced, and thus spheroidization when pulverized is easily achieved. Accordingly, a soft magnetic powder capable of producing a molded body having good filling properties and high density and good magnetic properties is obtained. When the content of Al is less than the above lower limit value, the filling properties, the oxidation resistance, and a withstand voltage during compacting of the soft magnetic powder may decrease. On the other hand, when the content of Al is more than the above upper limit value, the amount of Fe relatively decreases and the amount of oxide is excessive, and magnetic properties such as the permeability, the DC superimposition characteristics, and the saturation magnetic flux density may decrease.

The mass ratio of the content of Al to the content of Cr is defined as Al/Cr. The mass ratio Al/Cr is preferably 0.30 or less, more preferably 0.02 or more and 0.25 or less, and further preferably 0.04 or more and 0.20 or less. When the mass ratio Al/Cr is within the above range, a balance between the content of Cr and the content of Al can be optimized. Accordingly, the filling properties can be improved by a particle shape, and the magnetic properties can be improved by composition optimization. As a result, a molded body having particularly favorable magnetic properties is obtained.

When the mass ratio Al/Cr is less than the lower limit value, the insulation properties between the particles and the circularity of the particle shape are reduced, and the density of the molded body may decrease. On the other hand, when the mass ratio Al/Cr is more than the upper limit value, the magnetic properties during compacting may decrease.

The soft magnetic powder may further contain C. The content of C is preferably 0.050 mass % or less, more preferably 0.005 mass % or more and 0.045 mass % or less, and further preferably 0.015 mass % or more and 0.040 mass % or less. When the content of C is within the above range, hardness of the particles of the soft magnetic powder can be optimized. Accordingly, a soft magnetic powder showing appropriate deformability during compacting while ensuring appropriate fluidity before being compacted is obtained. Such a soft magnetic powder has good filling properties, thereby contributing to the production of a molded body having high density and good magnetic properties. When the content of C is less than the lower limit value, the hardness of the particles is insufficient, and the number of irregularly shaped particles may increase at a stage before the powder is compacted. Therefore, the fluidity of the soft magnetic powder may decrease, and the filling properties during compacting may decrease. On the other hand, when the content of C is more than the upper limit value, the hardness of the particles may be excessive. Therefore, the filling properties of the soft magnetic powder during compacting may decrease.

The soft magnetic powder may further contain Sn. The content of Sn is preferably 1.10 mass % or less, more preferably 0.05 mass % or more and 0.80 mass % or less, and further preferably 0.10 mass % or more and 0.40 mass % or less. When the content of Sn is within the above range, a particle shape of the soft magnetic powder can be closer to a spherical shape. Accordingly, even when a particle diameter is small, filling properties of the soft magnetic powder can be enhanced, and the density of the molded body can be increased.

When the content of Sn is less than the lower limit value, a circularity of the particle shape may decrease, and the filling properties may decrease. Accordingly, the density of the molded body may decrease, and magnetic properties such as the permeability and the DC superimposition characteristics may decrease. On the other hand, when the content of Sn is more than the upper limit value, the soft magnetic powder is easily oxidized, and an oxygen content may increase. Since the oxide generated along with the oxidation reduces a metal proportion in the molded body, the density of the molded body may be reduced, and the magnetic properties such as the permeability and the DC superimposition characteristics may decrease.

A mass ratio of a content of Sn to a content of Cr is Sn/Cr. The mass ratio Sn/Cr is preferably 0.02 or more and 0.30 or less, more preferably 0.03 or more and 0.25 or less, and further preferably 0.04 or more and 0.20 or less. When the mass ratio Sn/Cr is within the above range, a balance between the content of Cr and the content of Sn can be optimized. Accordingly, the filling properties can be improved by the particle shape, and the magnetic properties can be improved by composition optimization. As a result, a molded body having particularly favorable magnetic properties is obtained.

When the mass ratio Sn/Cr is less than the lower limit value, the oxidation resistance of the soft magnetic powder is improved, but the circularity of the particle shape decreases, and the filling properties of the soft magnetic powder may decrease. On the other hand, when the mass ratio Sn/Cr is more than the upper limit value, although the soft magnetic powder is spheroidized, the oxidation resistance may decrease, and the metal proportion in the molded body may decrease.

The soft magnetic powder may contain other elements as impurities in addition to the above elements. The impurities refer to elements other than the above-described elements that are inevitably mixed.

A content of the impurities is preferably 0.10 mass % or less, and more preferably 0.05 mass % or less for each element. A total content of the impurities is preferably 1.0 mass % or less. Within the range, other elements can be contained without affecting effects of the soft magnetic powder, and thus the impurities are allowed to be contained.

The soft magnetic powder according to the embodiment may contain oxygen as an impurity. An oxygen content in the soft magnetic powder is preferably 3000 ppm or less, more preferably 2000 ppm or less, and further preferably 1500 ppm or less in terms of a mass ratio. Accordingly, since deterioration ofa particle shape due to surface adhesion of the oxide is prevented, a soft magnetic powder having high filling properties during compacting is obtained. In addition, since a decrease in metal proportionin the molded body can be prevented, a molded body having good magnetic properties can be obtained. On the other hand, the lower limit value may not be set, but from the viewpoint of ensuring the insulation properties between particles, the lower limit value of an oxygen content is preferably 300 ppm or more, and more preferably 500 ppm or more. Accordingly, it is possible to sufficiently ensure the insulation properties between the particles and to obtain a molded body having a good withstand voltage.

The above composition is identified by the following analysis method.

Examples of the analysis method include an iron and steel-atomic absorption spectrometric method defined in JIS G 1257:2000, an iron and steel-ICP emission spectrometric method defined in JIS G 1258:2007, an iron and steel-method for spark discharge atomic emission spectrometric analysis defined in JIS G 1253:2002, an iron and steel-method for x-ray fluorescence spectrometric analysis defined in JIS G 1256:1997, and gravimetric, titration and absorption spectrometric methods defined in JIS G 1211 to JIS G 1237.

Specific examples include a solid-state optical emission spectrometer manufactured by SPECTRO, in particular a spark discharge optical emission spectrometer, model: SPECTROLAB, type: LAVMB08A, and an ICP device CIROS120 manufactured by Rigaku Corporation.

In particular, when identifying carbon (C) and sulfur (S), an infrared absorption method after combustion in a current of oxygen (combustion in high frequency induction furnace) defined in JIS G 1211:2011 is also used. Specifically, an example thereof is a carbon and sulfur analyzer CS-200 manufactured by LECO Corporation.

Further, when nitrogen (N) and oxygen (O) are identified, methods for determination of nitrogen content for an iron and steel defined in JIS G 1228:1997 and general rules for determination of oxygen in metal materials defined in JIS Z 2613:2006 are also used. Specifically, examples thereof include an oxygen/nitrogen analyzer TC-300/EF-300 manufactured by LECO Corporation, and an oxygen/nitrogen/hydrogen analyzer ONH836 manufactured by LECO Corporation.

### 1.3. Powder Properties

As described above, the soft magnetic powder according to the embodiment satisfies the following four elements (a) to (d).

### 1.3.1. (a) Average Circularity

In the soft magnetic powder according to the embodiment, an average circularity calculated based on an area and a perimeter of the particles is 0.80 or more and less than 0.95.

According to such a configuration, when the soft magnetic powder is compacted, a filling rate can be sufficiently increased. Therefore, a soft magnetic powder capable of producing a high-density molded body is obtained.

When the average circularity of the particles is less than the lower limit value, the filling properties of the soft magnetic powder decrease, and the density of the molded body decreases. On the other hand, when the average circularity of the particles is more than the upper limit value, a degree of difficulty in producing the soft magnetic powder increases. In addition, interactions between the particles and the binder may decrease, and the radial crushing strength of the molded body may decrease.

The average circularity of the particles is preferably 0.82 or more and 0.94 or less, and more preferably 0.85 or more and 0.93 or less.

The average circularity of the particles of the soft magnetic powder is measured as follows.

First, an image (secondary electron image) of the soft magnetic powder is captured using a scanning electron microscope (SEM). Next, the obtained image is read into image processing software. As the image processing software, for example, image analysis type particle size distribution measurement software “Mac-View” manufactured by Mountech Co., Ltd. is used. An imaging magnification is adjusted such that 50 or more and 100 or less particles appear in one image. Then, a plurality of images are acquired to obtain images of a total of 300 or more particles.

Next, the circularity of 300 or more particle images is calculated using software. When the circularity is represented by e, an area of a particle image is represented by S, and a perimeter of the particle image is represented by L, the circularity e is obtained using the following formula. e=4πS/L²

Next, an average value of the calculated circularities is obtained. The obtained average value is the average circularity of the particles of the soft magnetic powder.

### 1.3.2. (b) Particle Diameter D50

Regarding the soft magnetic powder according to the embodiment, in a volume-based cumulative particle size distribution curve measured by a laser diffraction method, when D10 is defined as a particle diameter at which a cumulative value on the small diameter side is 50%, the particle diameter D50 is 3.0 μm or more and 11.0 μm or less.

According to such a configuration, when the soft magnetic powder is compacted, the filling rate can be sufficiently increased. In addition, the mechanical strength of the obtained molded body can be enhanced.

When the particle diameter D50 of the soft magnetic powder is less than the lower limit value, the soft magnetic powder is likely to aggregate, the filling properties decrease, and the density and the mechanical strength of the molded body decrease. On the other hand, when the particle diameter D50 of the soft magnetic powder is more than the upper limit value, since gaps between the particles increase, the filling properties decrease, and the density and the mechanical strength of the molded body decrease.

The particle diameter D50 of the soft magnetic powder is preferably 3.5 μm or more and 10.0 μm or less, and more preferably 4.0 μm or more and 9.0 μm or less.

A laser diffraction type particle size distribution measurement device is used to acquire a cumulative particle size distribution curve by the laser diffraction method.

### 1.3.3. (c) Particle Diameter Difference D90−D10

Regarding the soft magnetic powder according to the embodiment, in a volume-based cumulative particle size distribution curve measured by a laser diffraction method, when D10 is defined as a particle diameter at which a cumulative value on the small diameter side is 10% and D90 is defined as a particle diameter at which a cumulative value on the small diameter side is 90%, a particle diameter difference D90−D10 between the particle diameter D90 and the particle diameter D10 is 4.0 μm or more and 22.0 μm or less.

According to such a configuration, since the particle size distribution of the soft magnetic powder is optimized, the filling rate can be sufficiently increased when the soft magnetic powder is compacted. In addition, since closer packing is possible, the mechanical strength of the obtained molded body can be enhanced.

When the particle diameter difference D90−D10 of the soft magnetic powder is less than the lower limit value, the soft magnetic powder has a small particle diameter difference between large-diameter particles and small-diameter particles, and thus the filling rate decreases and the mechanical strength of the molded body decreases. On the other hand, when the particle diameter difference D90−D10 of the soft magnetic powder is more than the upper limit value, the particle diameter difference between the large-diameter particles and the small-diameter particles of the soft magnetic powder increases, and thus the filling rate decreases and the mechanical strength decreases.

The particle diameter difference D90−D10 is preferably 6.0 μm or more and 20.0 μm or less, and more preferably 8.0 μm or more and 18.0 μm or less.

### 1.3.4. (d) Particle Diameter D50×Specific Surface Area (A×B)

Regarding the soft magnetic powder according to the embodiment, A×B is 1.20 or more and 2.40 or less, where A [μm] is the particle diameter D50 and B [m²/g] is the specific surface area.

According to such a configuration, the balance between the particle diameter D50 and the specific surface area of the soft magnetic powder is optimized. Accordingly, even when the amount of the binder to be added and to be used during molding is kept to be small, a surface of the particles can be uniformly covered with the binder, and thus a decrease in the mechanical strength of the molded body can be prevented. As a result, the space factor of the soft magnetic powder in the molded body can be enhanced, so that the magnetic properties of the molded body can be improved.

When the A×B of the soft magnetic powder is less than the lower limit value or more than the upper limit value, the balance between the particle diameter D50 and the specific surface area of the soft magnetic powder deteriorates, and therefore, when the amount of the binder to be added is small, the mechanical strength of the molded body decreases, or the amount of the binder to be added needs to be increased, and the space factor of the soft magnetic powder in the molded body decreases.

A×B of the soft magnetic powder is preferably 1.30 or more and 2.30 or less, and more preferably 1.40 or more and 2.20 or less.

The specific surface area of the soft magnetic powder is obtained using a BET method. As a specific surface area measurement device, for example, a BET type specific surface area measurement device HM1201-010 manufactured by Mountech Co., Ltd. may be used, and a specimen amount is 5 g.

### 1.4. Other Characteristics

### 1.4.1. Radial Crushing Strength of Molded Body

When a molded body is obtained using the soft magnetic powder according to the embodiment and an epoxy resin, the radial crushing strength of the obtained molded body is preferably 13 MPa or more, more preferably 15 MPa or more and 50 MPa or less, and further preferably 17 MPa or more and 30 MPa or less. When the radial crushing strength of the molded body is within the above range, a soft magnetic powder capable of producing a dust core having sufficiently high mechanical strength can be implemented. That is, it is possible to implement a soft magnetic powder which is less likely to cause chipping or cracking in the dust core and can implement a magnetic element having high reliability.

When the radial crushing strength of the molded body is less than the lower limit value, when the magnetic element is manufactured using the dust core, chipping, cracking, or the like may occur in the dust core. On the other hand, the radial crushing strength of the molded body may be more than the upper limit value, but in this case, there is a concern that the degree of difficulty in producing the dust core increases or dimension accuracy decreases.

The radial crushing strength of the molded body is measured as follows.

First, an epoxy resin corresponding to 2.0 mass % of the soft magnetic powder and the soft magnetic powder are mixed and compressed at a pressure of 98.1 MPa (1.0 t/cm²) to be molded. Next, the obtained molded body is subjected to a heat treatment at 600° C. for 1 hour in an air atmosphere. Accordingly, an annular molded body having an outer diameter of 14 mm, an inner diameter of 8 mm, and a thickness of 3 mm is obtained. Next, the radial crushing strength of the obtained molded body is measured. A method for measuring the radial crushing strength is a method according to the radial crushing strength test method defined in JIS Z 2507:2000. Specifically, when the radial crushing strength is K, the outer diameter is D, a radial wall thickness (half a difference between the outer diameter and the inner diameter) is t, the thickness is L, and a breaking load is F, the radial crushing strength K is obtained by K=F(D−t)/(Lt²).

### 1.4.2. Relative Density of Molded Body

When the molded body is obtained using the soft magnetic powder according to the embodiment and the epoxy resin, the relative density of the obtained molded body is preferably 71.0% or more, more preferably 71.5% or more and 80.0% or less, and further preferably 72.0% or more and 78.0% or less. When the relative density of the molded body is within the above range, it is possible to implement a soft magnetic powder capable of producing a dust core having a sufficiently high space factor of the soft magnetic powder and sufficiently high mechanical strength.

When the relative density of the molded body is less than the lower limit value, the space factor and the mechanical strength of the soft magnetic powder may not be sufficiently enhanced in the produced dust core. On the other hand, the relative density of the molded body may be more than the upper limit value, but in that case, the degree of difficulty in producing the soft magnetic powder capable of producing such a molded body may increase.

The relative density of the molded body is measured as follows.

First, an epoxy resin corresponding to 2.0 mass % of the soft magnetic powder and the soft magnetic powder are mixed and compressed at a pressure of 98.1 MPa (1.0 t/cm²) to be molded. Next, the obtained molded body is subjected to a heat treatment at 600° C. for 1 hour in an air atmosphere. Accordingly, an annular molded body having an outer diameter of 14 mm, an inner diameter of 8 mm, and a thickness of 3 mm is obtained. Next, a volume and a mass of the obtained molded body are measured. Meanwhile, a particle density of the used soft magnetic powder is measured. A dry automatic density meter capable of measurement by a gas displacement method is used to measure the particle density. Next, a density of the molded body is calculated based on the volume and the mass of the molded body, and the relative density of the molded body is calculated based on the density and the particle density of the obtained molded body.

### 1.4.3. Tap Density of Soft Magnetic Powder

The tap density of the soft magnetic powder according to the embodiment is preferably 3.70 g/cm³ or more and 5.20 g/cm³ or less, more preferably 3.90 g/cm³ or more and 5.00 g/cm³ or less, and still more preferably 4.00 g/cm³ or more and 4.90 g/cm³ or less. When the tap density is within the above range, a soft magnetic powder having particularly good filling properties is obtained. Accordingly, it is possible to produce a dust core having high density and good magnetic properties.

When the tap density is less than the lower limit value, the filling properties of the soft magnetic powder decrease, and the density of the dust core may decrease. On the other hand, when the tap density is more than the upper limit value, a degree of difficulty in producing the soft magnetic powder may increase.

The tap density of the soft magnetic powder is measured by a powder characteristic evaluation device. As the powder characteristic evaluation device, Powder Tester (registered trademark) PT-X manufactured by Hosokawa Micron Corporation is used.

### 2. Production Method for Soft Magnetic Powder

Next, an example of a method for producing the above soft magnetic powder will be described.

The soft magnetic powder may be a powder produced using any method. Examples of the method for producing the soft magnetic powder include a pulverization method, in addition to various atomization methods such as a water atomization method, a rotary water jet atomization method, and a gas atomization method. Among these, a powder produced by an atomization method is preferably used as the soft magnetic powder. According to the atomization method, a soft magnetic powder having a particle shape closer to a perfect sphere can be efficiently produced.

The atomization method is a method for producing a soft magnetic powder by causing a molten metal to collide with a liquid or a gas ejected at a high speed to atomize and cool the molten metal.

The water atomization method is a method of producing a soft magnetic powder from a molten metal by using a liquid such as water as a coolant, spraying the liquid in an inverted conical shape to converge the liquid to one point, and causing the molten metal to flow down toward the convergence point and to undergo collision.

The rotary water jet atomization method is a method for producing a soft magnetic powder by supplying a coolant along an inner peripheral surface of a cooling cylinder, swirling the coolant along the inner peripheral surface, spraying a jet of a liquid or a gas to a molten metal, and merging the scattered molten metal into the coolant.

The gas atomization method is a method for producing a soft magnetic powder from a molten metal by using a gas as a cooling medium, injecting the gas in an inverted conical shape that converges the gas to one point, and causing the molten metal to flow down toward the convergence point and undergo collision.

A casting temperature of a melting temperature is preferably set, with respect to a melting point Tm [° C.] of a constituent material of the soft magnetic powder, to Tm+200° C. or higher, more preferably Tm+220° C. or higher and Tm+350° C. or lower, and still more preferably Tm+250° C. or higher and Tm+300° C. or lower. Accordingly, it is possible to ensure a time during which the molten metal remains longer than that in the related art when the molten metal is atomized and solidified using various atomization methods. Accordingly, the particles are spheroidized.

In the water atomization method, for example, as described in International Publication No. WO99/11407, water injected at a high speed is injected in an inverted conical shape, and the molten metal is caused to collide with the vicinity of the apex. Accordingly, the vicinity of a collision point becomes a negative pressure due to a water film, and thus the molten metal becomes finer. In addition, oxidation of the molten metal can be reduced, and spheroidization can be achieved even when the produced soft magnetic powder is fine.

An apex angle of the injected water (an angle formed inside the apex of the inverted cone) is preferably 3° or more and 15° or less, more preferably 5° or more and 12° or less, and further preferably 6° or more and 10° or less. When the apex angle of the injected water is within the above range, the pressure in the vicinity of the collision point formed by the water film can be further reduced, and a time until the molten metal flowing down reaches the collision point can be increased. Accordingly, even when the produced soft magnetic powder is fine, spheroidization can be sufficiently achieved.

In the water atomization method, for example, as described in International Publication No. WO99/11407, the water may be injected into a tubular body called a suction pipe (ejector tube). In this case, the pressure inside the suction pipe is more likely to decrease, and the oxidation of the molten metal can be further reduced while further refining the molten metal.

The suction pipe extends downward from a nozzle that injects water. A length of the suction pipe is preferably 1500 mm or more and 5000 mm or less, more preferably 2000 mm or more and 3500 mm or less, and further preferably 2200 mm or more and 3000 mm or less. Accordingly, a soft magnetic powder having a higher circularity and a smaller specific surface area can be efficiently produced.

In the atomization method, the molten metal is allowed to flow down from a narrow nozzle hole, and an obtained fine stream of the molten metal is allowed to collide with a fluid jet. An outer diameter of the fine stream of the molten metal is not particularly limited, and is preferably 1.0 mm or more and 6.0 mm or less, more preferably 1.5 mm or more and 5.0 mm or less, and still more preferably 2.0 mm or more and 4.0 mm or less. Accordingly, the fluid jet can be easily and uniformly applied to the molten metal, and thus liquid droplets having an appropriate size can be easily and uniformly scattered. As a result, a spheroidized soft magnetic powder can be easily produced regardless of the particle size. In addition, the particle diameter of the produced soft magnetic powder can be adjusted according to the outer diameter of the fine stream.

The produced soft magnetic powder may be classified as necessary. Examples of classification methods include dry classification such as sieving classification, inertial classification, and centrifugal classification, and wet classification such as sedimentation classification.

### 3. Dust Core and Magnetic Element

Next, the dust core and the magnetic element according to the embodiment will be described.

The magnetic element according to the embodiment can be applied to various magnetic elements including a magnetic core, such as choke coils, an inductor, a noise filter, a reactor, a transformer, a motor, an actuator, a solenoid valve, and a generator. The dust core according to the embodiment can be applied to a magnetic core provided to these magnetic elements.

Hereinafter, two types of coil components will be representatively described as an example of the magnetic element.

### 3.1. Toroidal Type

First, a toroidal type coil component, which is the magnetic element according to the embodiment, will be described.

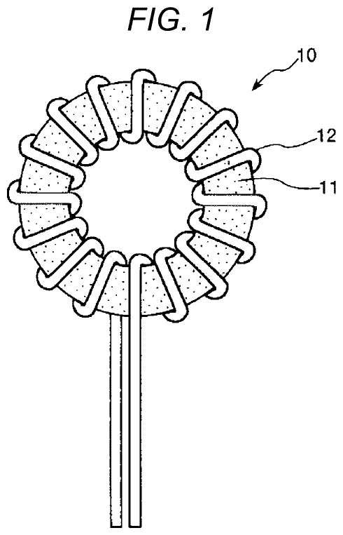

FIG. 1 is a plan view schematically showing a coil component 10 of a toroidal type. The coil component 10 shown in FIG. 1 includes a ring-shaped dust core 11 and a conductive wire 12 wound around the dust core 11.

The dust core 11 is obtained by mixing the soft magnetic powder according to the embodiment with a binder and compacting the obtained mixture. The dust core 11 is a green compact containing the soft magnetic powder according to the embodiment. Therefore, the dust core 11 having high density and high strength is obtained. In addition, the coil component 10 having high permeability and high strength is obtained. Therefore, when the coil component 10 is mounted on an electronic device or the like, it is possible to achieve high performance and miniaturization of the electronic device or the like.

Examples of constituent materials of the binder used for producing the dust core 11 include organic materials such as silicone-based resins, epoxy-based resins, phenol-based resins, polyamide-based resins, polyimide-based resins, and polyphenylene sulfide-based resins, and inorganic materials such as phosphates such as magnesium phosphate, calcium phosphate, zinc phosphate, manganese phosphate, and cadmium phosphate, and silicates such as sodium silicate.

Examples of constituent materials of the conductive wire 12 include a material having high conductivity, for example, a metal material including Cu, Al, Ag, Au, and Ni. An insulating film is provided on a surface of the conductive wire 12 as necessary.

A shape of the dust core 11 is not limited to the ring shape shown in FIG. 1, and may be, for example, a shape in which a part of the ring is missing, or a shape in which a shape in a longitudinal direction is linear.

The dust core 11 may contain, as necessary, a soft magnetic powder other than the soft magnetic powder according to the embodiment described above, or a non-magnetic powder.

### 3.2. Closed Magnetic Circuit Type

Next, a closed magnetic circuit type coil component, which is the magnetic element according to the embodiment, will be described.

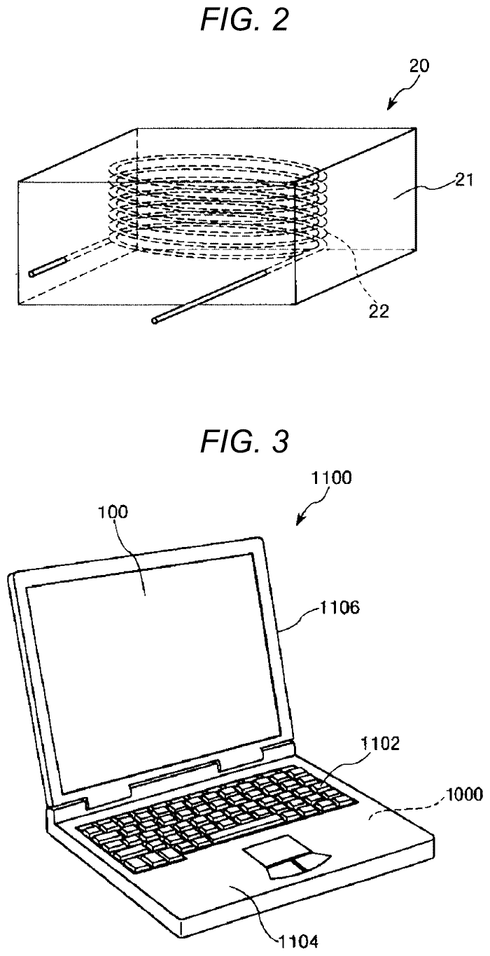

FIG. 2 is a transparent perspective view schematically showing a closed magnetic circuit type coil component 20.

Hereinafter, the closed magnetic circuit type coil component 20 will be described. In the following description, differences from the toroidal type coil component 10 will mainly be described, and description of similar matters will be omitted.

The coil component 20 shown in FIG. 2 is formed by embedding a conductive wire 22 formed in a coil-like shape inside a dust core 21. The dust core 21 is a green compact containing the soft magnetic powder according to the embodiment. Therefore, the dust core 21 having high density and high strength is obtained. In addition, the coil component 20 having high permeability and high strength is obtained. Therefore, when the coil component 20 is mounted on an electronic device or the like, it is possible to achieve high performance and miniaturization of the electronic device or the like.

The dust core 21 may contain, as necessary, a soft magnetic powder other than the soft magnetic powder according to the embodiment described above, or a non-magnetic powder.

### 4. Electronic Device

The electronic device including the magnetic element according to the embodiment will be described with reference to FIGS. 3 to 5.

FIG. 3 is a perspective view showing a configuration of a mobile personal computer 1100 which is an electronic device according to the embodiment. The personal computer 1100 shown in FIG. 3 includes a main body 1104 including a keyboard 1102 and a display unit 1106 including a display 100. The display unit 1106 is pivotally supported by the main body 1104 via a hinge structure. Such a personal computer 1100 includes therein a magnetic element 1000 such as a choke coil, an inductor, or a motor for a switching power supply.

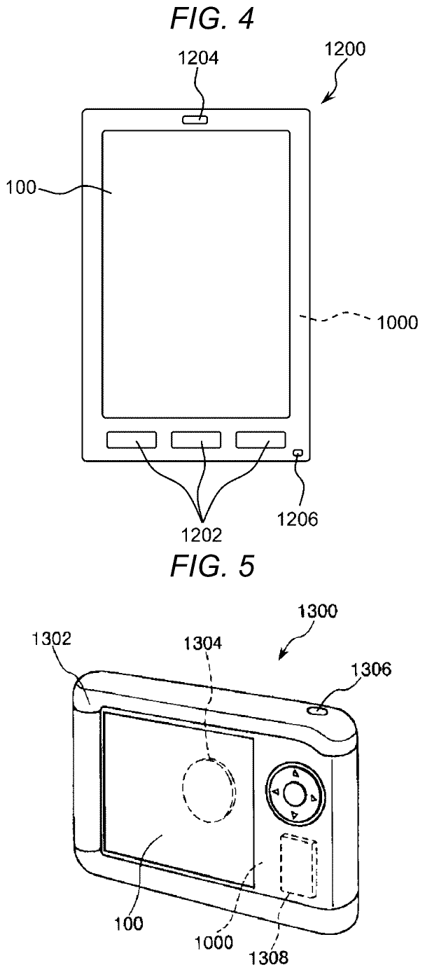

FIG. 4 is a plan view showing a configuration of a smartphone 1200 which is an electronic device according to the embodiment. The smartphone 1200 shown in FIG. 4 includes a plurality of operation buttons 1202, an earpiece 1204, and a mouthpiece 1206. In addition, the display 100 is disposed between the operation buttons 1202 and the earpiece 1204. Such a smartphone 1200 includes therein the magnetic element 1000 such as an inductor, a noise filter, or a motor.

FIG. 5 is a perspective view showing a configuration of a digital still camera 1300 which is an electronic device according to the embodiment. The digital still camera 1300 photoelectrically converts an optical image of a subject with an imaging element such as a charge coupled device (CCD) to generate an imaging signal.

The digital still camera 1300 shown in FIG. 5 includes the display 100 provided at a rear surface of a case 1302. The display 100 functions as a finder that displays the subject as an electronic image. A light receiving unit 1304 including an optical lens, a CCD, and the like is provided on a front surface side of the case 1302, that is, on a back surface side in the drawing.

When a photographer confirms a subject image displayed on the display 100 and presses a shutter button 1306, a CCD imaging signal at this time is transferred to and stored in a memory 1308. Such a digital still camera 1300 also includes therein the magnetic element 1000 such as an inductor or a noise filter.

Examples of the electronic device according to the embodiment include, in addition to the personal computer 1100 in FIG. 3, the smartphone 1200 in FIG. 4, and the digital still camera 1300 in FIG. 5, a mobile phone, a tablet terminal, a watch, inkjet discharge devices such as an inkjet printer, a laptop personal computer, a television, a video camera, a video tape recorder, a car navigation device, a pager, an electronic notebook, an electronic dictionary, a calculator, an electronic game device, a word processor, a workstation, a videophone, a crime prevention television monitor, electronic binoculars, a POS terminal, medical devices such as an electronic thermometer, a blood pressure meter, a blood glucose meter, an electrocardiogram measurement device, an ultrasonic diagnostic device, and an electronic endoscope, a fish finder, various measuring devices, instruments for a vehicle, an aircraft, and a ship, moving object control devices such as an automobile control device, an aircraft control device, a railway vehicle control device, and a ship control device, and a flight simulator.

Such an electronic device includes the magnetic element according to the embodiment. Accordingly, effects of the magnetic element can be provided, and the electronic device can have high performance and a small size.

### 5. Effects of Embodiment

As described above, the soft magnetic powder according to the embodiment contains Fe as a main component, Si having a content of 2.5 mass % or more and 7.5 mass % or less, Cr having a content of 1.0 mass % or more and 10.0 mass % or less, and impurities having a total content of 1.0 mass % or less. In the soft magnetic powder according to the embodiment, an average circularity calculated based on an area and a perimeter of the particles is 0.80 or more and less than 0.95. Further, in the soft magnetic powder according to the embodiment, in the volume-based cumulative particle size distribution curve measured using the laser diffraction method, when D10 is the particle diameter when the cumulative value on the small diameter side is 10%, D50 is the particle diameter when the cumulative value on the small diameter side is 50%, and D90 is the particle diameter when the cumulative value on the small diameter side is 90%, the particle diameter D50 is 3.0 μm or more and 11.0 μm or less, and a particle diameter difference D90−D10 between the particle diameter D90 and the particle diameter D10 is 4.0 μm or more and 22.0 μm or less. Regarding the soft magnetic powder according to the embodiment, A×B is 1.20 or more and 2.40 or less, where A [μm] is the particle diameter D50 and B [m²/g] is the specific surface area.

According to such a configuration, it is possible to implement a soft magnetic powder capable of producing a molded body having high density and high strength while reducing an amount of a binder to be added during molding.

In the soft magnetic powder according to the embodiment, when the epoxy resin is mixed at a ratio of 2.0 mass % and molded into an annular shape having an outer diameter of 14 mm, an inner diameter of 8 mm, and a thickness of 3 mm at a pressure of 98.1 MPa (1.0 t/cm²), the radial crushing strength of the obtained molded body is preferably 13 MPa or more.

According to such a configuration, it is possible to implement a soft magnetic powder capable of producing a dust core having sufficiently high mechanical strength. That is, it is possible to implement a soft magnetic powder which is less likely to cause chipping or cracking in the dust core and can implement a magnetic element having high reliability.

In the soft magnetic powder according to the embodiment, the relative density of the molded body described above is preferably 71.0% or more.

According to such a configuration, it is possible to implement a soft magnetic powder capable of producing a dust core having a sufficiently high space factor of the soft magnetic powder and sufficiently high mechanical strength.

In the soft magnetic powder according to the embodiment, the tap density is preferably 3.70 g/cm³ or more and 5.20 g/cm³ or less.

According to such a configuration, a soft magnetic powder having particularly good filling properties is obtained. Accordingly, it is possible to produce a dust core having high density and good magnetic properties.

The dust core according to the embodiment includes the soft magnetic powder according to the embodiment.

According to such a configuration, a dust core having high density and high strength is obtained.

The magnetic element according to the embodiment includes the dust core according to the embodiment.

According to such a configuration, a magnetic element having high permeability and high strength is obtained.

An electronic device according to the embodiment includes the magnetic element according to the embodiment.

According to such a configuration, it is possible to obtain an electronic device having high performance and a small size.

The soft magnetic powder, the dust core, the magnetic element, and the electronic device of the present disclosure are described above based on the preferred embodiment, and the present disclosure is not limited thereto. For example, shapes of the dust core and the magnetic element are not limited to those shown in the drawings, and may be any shapes.

### EXAMPLES

Next, specific examples of the present disclosure will be described.

### 6. Production of Soft Magnetic Powder

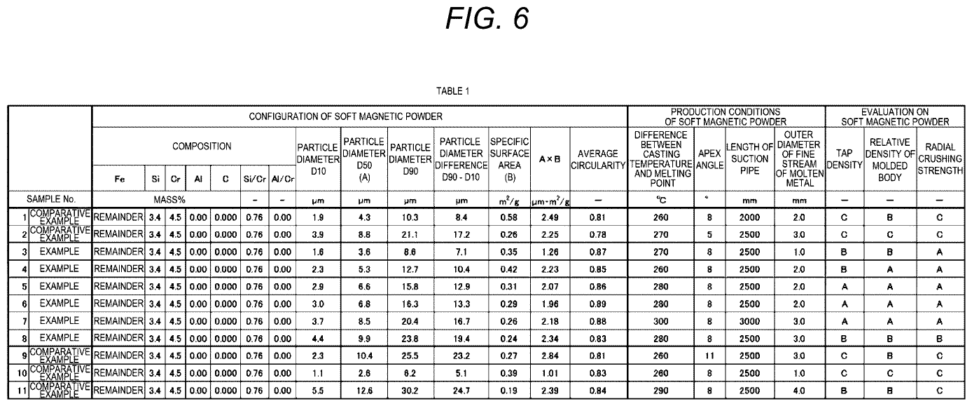

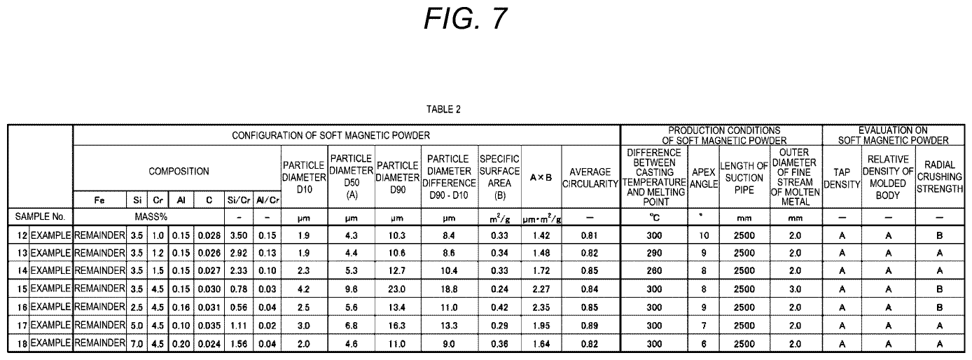

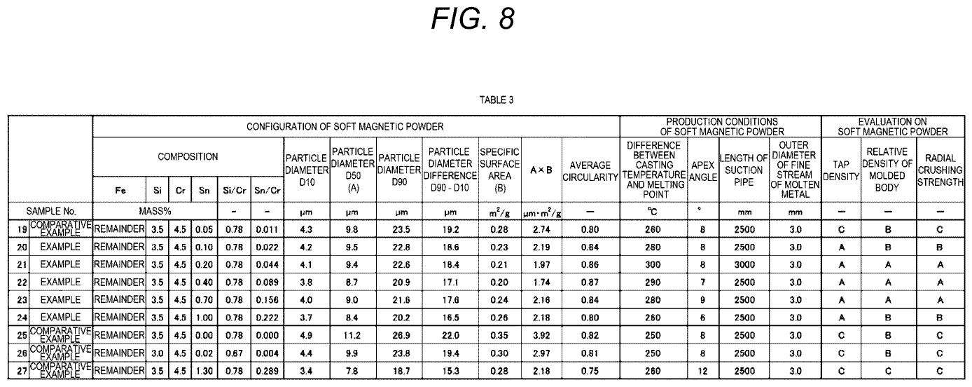

FIG. 6 shows Table 1 indicating configurations, production conditions, and evaluation results of the soft magnetic powders of sample Nos. 1 to 11. FIG. 7 shows Table 2 indicating the configurations, the production conditions, and the evaluation results of the soft magnetic powders of sample Nos. 12 to 18. FIG. 8 shows Table 3 indicating the configurations, the production conditions, and the evaluation results of the soft magnetic powders of sample Nos. 19 to 27.

### 6.1. Sample No. 1

First, a soft magnetic powder was obtained using a water atomization method. A composition of the obtained soft magnetic powder is as shown in Table 1 (FIG. 6). Production conditions of the soft magnetic powder by the water atomization method are shown in Table 1.

The obtained soft magnetic powder was measured or calculated for the particle diameter D10, the particle diameter D50 (A), the particle diameter D90, the particle diameter difference D90−D10, the specific surface area (B), A×B, and the average circularity. Measurement results and calculation results are shown in Table 1.

### 6.2. Sample Nos. 2 to 27

Soft magnetic powders were obtained in the same manner as in Sample No. 1 except that compositions of the soft magnetic powders were changed as shown in Table 1 (FIG. 6), Table 2 (FIG. 7), or Table 3 (FIG. 8).

In Tables 1, 2, and 3, among the soft magnetic powders of the respective sample Nos., those corresponding to the present disclosure are “Examples”, and those not corresponding to the present disclosure are “Comparative Examples”.

### 7. Evaluation on Soft Magnetic Powder

### 7.1. Tap Density of Soft Magnetic Powder

The tap density of the soft magnetic powder of each sample No. was measured. Then, the measurement results were evaluated in three stages A to C in light of the following evaluation criteria. Evaluation results are shown in Tables 1, 2, and 3.
A: The tap density is 4.00 g/cm³ or more and 4.90 g/cm³ or less.
B: The tap density is 3.70 g/cm³ or more and 5.20 g/cm³ or less (excluding the range of A).
C: The tap density is less than 3.70 g/cm³ or more than 5.20 g/cm³.

### 7.2. Relative Density of Molded Body of Soft Magnetic Powder

The soft magnetic powder of each sample No. was compacted, and the relative density of the obtained molded body was measured. Then, the measurement results were evaluated in three stages A to C in light of the following evaluation criteria. Evaluation results are shown in Tables 1, 2, and 3.
A: The relative density of the molded body is 72.0% or more and 78.0% or less.
B: The relative density of the molded body is 71.0% or more and less than 72.0% or more than 78.0% and 80.0% or less.
C: The relative density of the molded body is less than 71.0% or more than 80.0%.

### 7.3. Radial Crushing Strength of Molded Body of Soft Magnetic Powder

The soft magnetic powder of each sample No. was compacted, and the radial crushing strength of the obtained molded body was measured. Then, the measurement results were evaluated in three stages A to C in light of the following evaluation criteria. Evaluation results are shown in Tables 1, 2, and 3.
A: The radial crushing strength of the molded body is 17 MPa or more and 30 MPa or less.
B: The radial crushing strength of the molded body is 13 MPa or more and less than 17 MPa, or more than 30 MPa and 50 MPa or less.
C: The radial crushing strength of the molded body is less than 13 MPa or more than 50 MPa.

As shown in Tables 1, 2, and 3, it is found that the soft magnetic powder of each example has high filling properties, and a molded body having high density and high strength can be produced. Therefore, it is found that a magnetic element having high permeability and high reliability can be produced by using the soft magnetic powder according to the present disclosure.

In addition, when the same evaluation was performed by reducing an amount of the epoxy resin to be used by 10%, the same evaluation results as in Table 1 were obtained. Specifically, when a molded body was produced using the soft magnetic powders of sample Nos. 1 to 11 and the radial crushing strength was measured, the same evaluation results as in Table 1 were obtained. Therefore, it is found that good results are obtained by using the soft magnetic powder according to the present disclosure even when the amount of the binder to be added during molding is reduced.

What is claimed is:

1. A soft magnetic powder comprising:
Fe as a main component;
Si having a content of 2.5 mass % or more and 7.5 mass % or less;
Cr having a content of 1.0 mass % or more and 10.0 mass % or less; and
impurities having a total content of 1.0 mass % or less, wherein
an average circularity calculated based on an area and a perimeter of particles is 0.80 or more and less than 0.95,
in a volume-based cumulative particle size distribution curve measured by a laser diffraction method, when D10 is defined as a particle diameter at which a cumulative value on the small diameter side is 10%, D50 is defined as a particle diameter at which a cumulative value on the small diameter side is 50%, and D90 is defined as a particle diameter at which a cumulative value on the small diameter side is 90%, the particle diameter D50 is 3.0 μm or more and 11.0 μm or less, a particle diameter difference D90−D10 between the particle diameter D90 and the particle diameter D10 is 4.0 μm or more and 22.0 μm or less, and
A×B is 1.20 or more and 2.40 or less, where A [μm] is the particle diameter D50 and B [m²/g] is a specific surface area.

2. The soft magnetic powder according to claim 1, wherein
when an epoxy resin is mixed at a ratio of 2.0 mass % and molded into an annular shape having an outer diameter of mm, an inner diameter of 8 mm, and a thickness of 3 mm at a pressure of 98.1 MPa, which is 1.0 t/cm², a radial crushing strength of an obtained molded body is 13 MPa or more.

3. The soft magnetic powder according to claim 2, wherein
a relative density of the molded body is 71.0% or more.

4. The soft magnetic powder according to claim 1, wherein
a tap density is 3.70 g/cm³ or more and 5.20 g/cm³ or less.

5. A dust core comprising
the soft magnetic powder according to claim 1.

6. A magnetic element comprising:
the dust core according to claim 5.

7. An electronic device comprising:
the magnetic element according to claim 6.
